(19) United States
(12) Patent Application Publication
(10) Pub. No.: US 2007/0290665 A1
(43) Pub. Date: Dec. 20, 2007

(54) Low dropout linear regulator having high power supply rejection and low quiescent current

(75) Inventor: Farhood Moraveji, Saratoga, CA (US)

Correspondence Address: PERKINS COIE LLP;PATENT-SEA, P.O. BOX 1247, SEATTLE, WA, 98111-1247, US

(73) Assignee: Monolithic Power Systems, Inc., Los Gatos, CA (US)

(21) Appl. No.: 11/455,022

(22) Filed: Jun. 15, 2006

(51) Int. Cl. G05F 1/00

(52) U.S. Cl. 323/274

(57) ABSTRACT

Methods and apparatus are disclosed for providing stable voltage references from within a low dropout voltage regulator. Some embodiments utilize dependable semiconductor inherent attributes to generate a voltage reference, such as a band-gap voltage reference.

### TECHNICAL FIELD

Disclosed embodiments relate, in general, to low dropout (LDO) linear voltage regulators and, in particular, to voltage regulators with an internal reference voltage.

### BACKGROUND

Almost all electronic devices contain a regulated power supply, which are typically designed to match the requirements of the electronic devices. An important part of these power supplies is a voltage regulator, which functions to maintain their output voltage and/or current within a desired range. A linear regulator is a voltage regulator based on an active device such as a bipolar junction transistor or field effect transistor operating in its “linear region.” A linear regulating device acts substantially like a variable resistor.

A low dropout or LDO regulator is a DC linear voltage regulator which has a very small input-output differential voltage. The regulator dropout voltage determines the lowest usable supply voltage. Due to the increased demand regarding efficiency and the growing problems with the power dissipation in today's systems, low dropout regulators (LDOs) are the preferred choice among linear regulators. Another important characteristic is the quiescent current, or the current flowing through the system when no load is present. Quiescent current causes a causes a difference between the input and output currents. Quiescent current limits the efficiency of the LDO regulators and, thus, should be minimized.

An important part of most voltage regulators is a voltage reference, which provides a reference voltage that is compared against the output of the voltage regulator. Circuitry within the voltage regulator controls the output of the voltage regulator to follow the voltage reference at all times. Therefore, changes of the voltage reference directly and undesirably affect the voltage output of the regulator.

### BRIEF DESCRIPTION OF THE DRAWINGS

FIG. 1 is a circuit diagram of a prior art linear voltage regulator.

FIG. 2 is a high-level circuit diagram of a LDO voltage regulator in accordance with an embodiment of the invention.

FIG. 3 a detail circuit diagram of the LDO voltage regulator of FIG. 2.

### DETAILED DESCRIPTION

The following disclosed embodiments describe stable and low dropout voltage regulators that also generate their own voltage references. Some embodiments utilize semiconductor inherent attributes to generate the voltage references.

In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In some instances, well-known structures, materials, or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

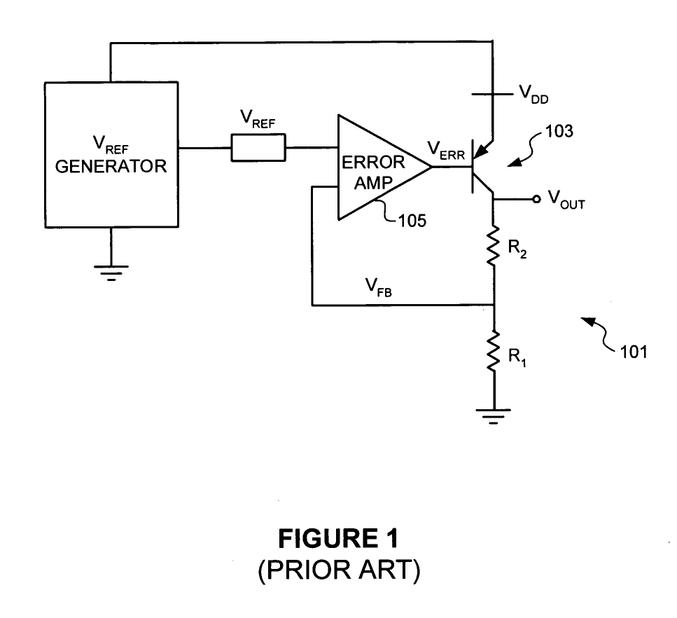

FIG. 1 shows a typical prior art implementation of a linear DC/DC voltage regulator which employs a classical negative-feedback closed-loop control system to keep the output voltage Vₒᵤₜ at a desired level, where Vₒᵤₜ is dictated by a reference voltage V_{ref}. In the feedback part of the circuit of FIG. 1, a fraction of the output voltage, V_{fb}, is fed back to an error amplifier 105. Resistors R1 and R2 produce the feedback gain and determine what fraction of Vₒᵤₜ is fed back as V_{fb}, where V_{fb}=Vₒᵤₜ×R1/(R1+R2).

In the feed-forward part of the circuit of FIG. 1, an error amplifier 105 compares V_{fb} with the reference voltage V_{ref} and amplifies the resulting deviation/error to generate an error voltage Vₑᵣᵣ. In the feed-forward part of the circuit of FIG. 1, the actuating signal Vₑᵣᵣ is used to drive transistor 103, which acts as an actuator in this control system. Transistor 103 regulates the amount of current passing through R1 and R2 and, therefore, generates the output voltage Vₒᵤₜ.

In this classical closed-loop control system, any change of Vₒᵤₜ generates an error signal Vₑᵣᵣ which forces Vₒᵤₜ back to its designated level. A drop in Vₒᵤₜ causes an increase in Vₑᵣᵣ, subsequently an increase in the current passing through R1 and R2. And a rise in Vₒᵤₜ causes a drop in Vₑᵣᵣ and subsequently a drop in the current passing through R1 and R2. Because the circuit continuously keeps V_{fb} equal to V_{ref}, and since V_{fb}=Vₒᵤₜ×R1/(R1+R2), therefore, Vₒᵤₜ=V_{ref}(130 R₂/R₁).

As seen from the above equation, the bottle neck in the performance of the voltage regulator of FIG. 1 is the stability of the reference voltage V_{ref}. Such circuit performs very well in terms of following the reference voltage; however, providing a dependable and a stable reference voltage is another matter altogether and is a burden on the user of the voltage regulator. For example, as illustrated in FIG. 1, any change of the V_{dd} will change V_{ref} via the V_{ref} generator and a V_{ref} change is as much as V_{ref}+ΔV_{dd}/(PSRR×V_{ref}), where PSRR is the power supply rejection ratio of the V_{ref} generator circuit. As can be seen, to obtain a stable V_{ref}, PSRR should be very large.

The following disclosed embodiments provide stable voltage references from within the voltage regulating circuit. Some embodiments employ dependable semiconductor inherent attributes to generate a voltage reference, such as a band-gap voltage reference.

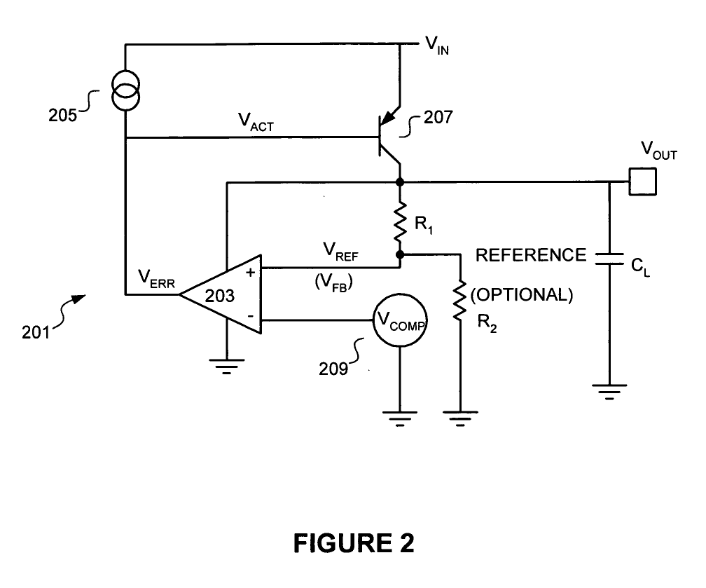

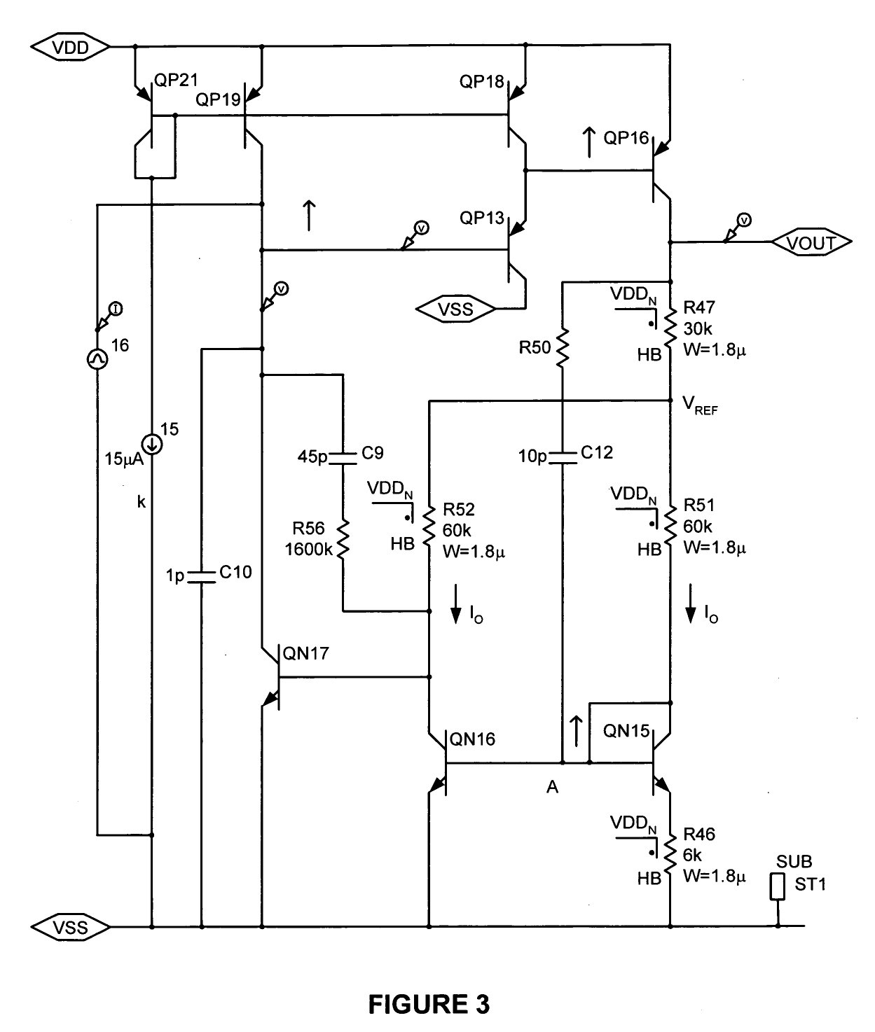

FIG. 2 is a simplified high-level circuit diagram of an LDO voltage regulator in accordance with an embodiment of the present invention. In FIG. 2, while reference voltage V_{comp}, 209, is illustrated separately, it is not to be provided from the outside of the circuit and V_{ref} is derived from the regulated output voltage Vₒᵤₜ, which significantly enhances the PSRR. As will become clearer from FIG. 3, V_{comp} is also generated within the circuit and is regulated by the error amplifier 203. In some embodiments V_{comp} is a part of the error amplifier 203.

FIG. 2 also illustrates a control loop, wherein V_{fb} is a feedback signal that carries some information regarding the output voltage Vₒᵤₜ to an error amplifier 203. Resistors R1 and R2 determine the feedback gain and are employed to send back only a fraction of Vₒᵤₜ. Resistor R2 is optional if Vₒᵤₜ is to be fed back without significant reduction.

In the circuit of FIG. 2, the feedback signal V_{fb} is compared with the internally generated reference voltage V_{comp} and is amplified to produce an error signal Vₑᵣᵣ. The error signal Vₑᵣᵣ, with the assistance of the current source 205, which may be a cascade of current sources, produces an actuating signal V_{act} that controls transistor 207. In the control loop of FIG. 2, transistor 207 acts as an actuator that regulates the flow of current through R1 and also to the output. Note that the error signal Vₑᵣᵣ and/or V_{act} may be voltage or current signals.

FIG. 3 is a more detailed circuit diagram of the LDO linear regulator 201, depicted in FIG. 2. The pass transistor 207 is designated as QP16. Transistors QP13 and QN17 are used to help drive the pass transistor QP16, and also contribute to the error amplification process. Transistors QP13 and QN17 are in the feedback path for controlling transistor QP16. Transistors QP18 and QP21 form a current source. Transistors QP21 and QP19 also form another current source.

The current through resistor R47 is determined by adding the currents through R51 and R52, which are the two branches of a current mirror that is partially defined by transistors QN15 and QN16. Because in this current mirror the currents through R51 and R52 are equal and the same current passes through R51 and R46, the current through the resistor R47 will be equal to two times the current passing through the resistor R46. The voltage across R46 is equal to the difference of the base-emitter voltage of QN15 and QN16. Therefore, the current through R46 can be written as:

V_{R46}=V_{BE(QN16)}−V_{BE(QN15)}=ΔV_{BE}=V_{T}ln10,

which is about 60 mv at room temperature. Therefore I_{R46} can be written as:

I_{R46}=V_{R46}/R46=ΔV_{BE}/R46=V_{T}ln10/R46=Iₒ

or as I_{R46}=I_{R51}=½I_{R47},

which results in: I_{R47}=2ΔV_{BE}/R46.

Furthermore, V_{ref} can be written as:

$$\begin{matrix}{V}_{ref} = {V}_{BE ( QN16 )} + {I}_{o} \times R52 \\ = {V}_{BE ( QN16 )} + ( {V}_{T} ln 10 ) \times R52 / R46 , or \\ = {V}_{BE ( QN16 )} + {I}_{R46} \times R51 .\end{matrix}$$

Therefore, the voltage at the output can be written as:

$$\begin{matrix}{V}_{out} = {V}_{ref} + {I}_{R47} \times R47 , or \\ = {V}_{BE ( QN16 )} + {I}_{R46} \times R51 + {I}_{R47} \times R47 \\ = {V}_{BE ( QN16 )} + Δ {V}_{BE} \times R51 / R46 + 2 Δ {V}_{BE} \times R47 / R46 \\ = {V}_{BE ( QN16 )} + Δ {V}_{BE} ( R51 + 2 R47 ) / R46 \\ = {V}_{BE ( QN16 )} + ( {V}_{T} ln 10 ) ( R51 + 2 R47 ) / R46 .\end{matrix}$$

### As evident from the above equation, a low Vₒᵤₜ can be achieved by choosing different resistor values.

In the example circuit of FIG. 3, Vₒᵤₜ=V_{BE(QN16)}+20ΔV_{BE}. Furthermore, in this embodiment any change in Vₒᵤₜ will translate into a change in V_{ref} which affects the base of transistor QN17. The signals at the base of transistor QN17, in turn, send a similar signal to the base of transistor QP13, which controls transistor QP16 and which, in turn, regulates Vₒᵤₜ.

The passage of these signals through QN17 and QP13 also amplifies the error signal originating from transistor QN16. Hence, the control loop of the voltage regulator of FIG. 3 utilizes the base-emitter voltage V_{BE} and ΔV_{BE} of the current mirror transistors as the foundation of a stable reference voltage without resorting to any outside voltage reference.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps or components are presented in a given order, alternative embodiments may perform routines having steps or components in a different order. The teachings of the invention provided herein can be applied to other systems, not necessarily the network model described here. The elements and acts of the various embodiments described above can be combined to provide further embodiments and some steps or components may be deleted, moved, added, subdivided, combined, and/or modified. Each of these steps may be implemented in a variety of different ways. Also, while these steps are shown as being performed in series, these steps may instead be performed in parallel, or may be performed at different times.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words in the above detailed description using the singular or plural number may also include the plural or singular number respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The teachings of the invention provided herein could be applied to other systems, not necessarily the system described herein. These and other changes can be made to the invention in light of the detailed description. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above detailed description. While the above description details certain embodiments of the invention and describes the best mode contemplated, no matter how detailed the above appears in text, the invention can be practiced in many ways. Details of the network model and its implementation may vary considerably in their implementation details, while still being encompassed by the invention disclosed herein. As noted above, particular terminology used when describing certain features, or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

I/We claim:

1. A low dropout voltage regulator, comprising:
a controllable pass device situated between a power source and an output port of the regulator for controlling current from the power source to the output port;
an error amplifier that includes an internally generated reference voltage, wherein the error amplifier is in electrical communication with the output port through a first resistor and senses voltage differences between the output port and the internal reference voltage, and wherein the reference voltage is based on at least one inherent attribute of an error amplifier component; and
a feedback connection between the error amplifier and the controllable pass device, wherein the feedback connection includes at least one current source to control the pass device based on the sensed voltage difference between the output port voltage and the internal reference voltage.

2. The low dropout voltage regulator of claim 1, wherein the controllable pass device is a transistor.

3. The low dropout voltage regulator of claim 1, wherein the error amplifier comprises a current mirror and the internal reference voltage is based on a base-emitter voltage of current mirror transistors.

4. The low dropout voltage regulator of claim 1, wherein the reference voltage is based on a band-gap voltage of an error amplifier transistor.

5. The low dropout voltage regulator of claim 1, wherein at least a part of the error amplification comprises a combination of a transistor and a current source.

6. The low dropout voltage regulator of claim 1, wherein the amplification includes two cascading stages, each comprising a combination of a transistor and a current source.

7. The low dropout voltage regulator of claim 1, wherein the pass device is a PNP transistor, and wherein the error amplifier comprises a current mirror that comprises two NPN transistors an emitter of one of which is connected to a lower voltage than the power source voltage and an emitter of the other NPN transistor is connected to the lower voltage through a second resistor and collectors of both NPN transistors are connected to the first resistor through two substantially similar third and fourth resistors, and wherein the output voltage is a function of a base-emitter voltage of at least one of the NPN transistors.

8. The low dropout voltage regulator of claim 1, wherein the controllable pass device is a transistor the gate of which is connected to a current source and also to a second pass transistor the gate of which is controlled by an output of the error amplifier.

9. A method of low dropout voltage regulating, the method comprising:
controlling current from a power source to an output port using a controllable pass device that is situated between the power source and the output port;
sensing a voltage difference between the output port and an internally generated reference voltage using an error amplifier that is in electrical communication with the output port, wherein the reference voltage is based on at least one inherent attribute of an error amplifier component; and
regulating the pass device based on the sensed voltage difference by feeding back a signal from the error amplifier to the controllable pass device.

10. The method of claim 9, wherein the controllable pass device is a transistor.

11. The method of claim 9, wherein the error amplifier comprises a current mirror and the internal reference voltage is partially based on a band-gap voltage of a current mirror transistor.

12. The method of claim 9, wherein there is a second series resistor between the first resistor and ground.

13. The method of claim 9, wherein at least a part of the error amplification comprises a combination of a transistor and a current source.

14. The method of claim 9, wherein the amplification includes two or more cascading stages each comprising a combination of a transistor and a current source.

15. The method of claim 9, wherein the pass device is a PNP transistor, and wherein the error amplifier comprises a current mirror that comprises two NPN transistors an emitter of one of which is connected to a lower voltage than the the power source voltage and an emitter of the other NPN transistor is connected to the lower voltage through a second resistor and collectors of both NPN transistors are connected to a first resistor through two substantially similar third and fourth resistors, and wherein the output voltage is a function of a base-emitter voltage of the NPN transistors.

16. The method of claim 9, wherein the controllable pass device is a transistor the gate of which is connected to a current source and also to a second pass transistor the gate of which is controlled by an output of the error amplifier.

17. A low dropout voltage regulating apparatus comprising:
means for controlling current from a power source to an output port;
means for sensing a voltage difference between the output port and an internally generated reference voltage, wherein the reference voltage is partially based on at least an inherent attribute of a semiconductor component;
means for amplifying the sensed voltage difference; and
means for regulating the controlling means, based on the amplified sensed voltage difference.

18. The apparatus of claim 17, wherein the means for sensing a voltage difference between the output port and an internally generated reference voltage comprises a current mirror and the internal reference voltage is based on a band-gap voltage of the current mirror transistor.

19. The apparatus of claim 17, wherein the means for amplification includes two or more cascading stages each comprising a combination of a transistor and a current source.

20. The apparatus of claim 17, wherein the means for controlling current from a power source to an output port is a PNP transistor, and wherein the means for amplification comprises a current mirror that comprises two NPN transistors an emitter of one of which is connected to a lower voltage than a power source voltage and an emitter of the other NPN transistor is connected to the lower voltage through a resistor.
